(19) United States
(12) Patent Application Publication
(10) Pub. No.: US 2016/0355704 A1
(43) Pub. Date: Dec. 8, 2016

(54) PRESSURE SENSITIVE ADHESIVE SHEET, OPTICAL FILM WITH PRESSURE SENSITIVE ADHESIVE, AND MANUFACTURING METHOD OF IMAGE DISPLAY DEVICE

(71) Applicant: NITTO DENKO CORPORATION, Osaka (JP)

(72) Inventors: Shou TAKARADA, Osaka (JP); Atsushi YASUI, Osaka (JP)

(73) Assignee: NITTO DENKO CORPORATION, Osaka (JP)

(21) Appl. No.: 15/172,462

(22) Filed: Jun. 3, 2016

(30) Foreign Application Priority Data
Jun. 4, 2015 (JP) 2015-114318

(51) Int. Cl. C09J 7/02; B32B 37/12; B32B 38/10; C09J 5/06; G02B 5/30

(52) U.S. Cl. CPC C09J 7/0217; C09J 5/06; G02B 5/3033; B32B 38/10; B32B 37/12; C09J 2433/00; B32B 2307/412; B32B 2457/208; B32B 2307/42

(57) ABSTRACT

A pressure sensitive adhesive sheet and an optical film with a pressure sensitive adhesive are disclosed. The pressure sensitive adhesive sheet comprises a first pressure sensitive adhesive layer and a first protective sheet releasably attached to one surface of the first pressure sensitive adhesive layer. The first pressure sensitive adhesive layer contains an ultraviolet curable pressure sensitive adhesive. The first protective sheet has a transmittance of 1% or less to an ultraviolet ray with a wavelength of 360 nm.

### TECHNICAL FIELD

The present invention relates to a pressure sensitive adhesive sheet and an optical film with a pressure sensitive adhesive including the pressure sensitive adhesive sheet. The present invention also relates to a method for producing an image display device using the optical film with a pressure sensitive adhesive.

### BACKGROUND ART

Liquid crystal displays and organic EL displays are widely used as various kinds of image display devices of mobile phones, car navigation devices, personal computer monitors, televisions and so on. On a viewing-side outermost surface of an image display panel (a liquid crystal panel or an organic EL panel), a front transparent plate (also referred to as a “window layer” etc.) such as a transparent resin plate or a glass plate may be provided, for the purpose of for example, preventing damage to the image display panel due to impact from the outer surface.

For arranging a front transparent plate on a front surface of an image display panel, an “interlayer filling structure” is employed in which the front transparent plate and the image display panel are bonded with a pressure sensitive adhesive layer therebetween. In the interlayer filling structure, a gap between the panel and the front transparent plate is filled with a pressure sensitive adhesive to decrease a refractive index difference at the interface, and therefore deterioration of visibility due to reflection and scattering is suppressed. JP-A-2012-237965 and JP-A-2014-115468 disclose an optical film with a pressure sensitive adhesive on both sides, in which a pressure sensitive adhesive layer for bonding the film to an image display panel is provided on one surface and an interlayer filling pressure sensitive adhesive for bonding the film to a front transparent plate is provided on the other surface.

A colored layer for decoration and light shielding is formed at the peripheral edge of the front transparent plate on the panel side surface. When the decorative printed layer is formed at the peripheral edge of the transparent plate, a printing level difference of about 10 μm to several tens μm is generated. When a sheet pressure sensitive adhesive is used as an interlayer filler, bubbles are easily generated on the periphery of the printing level difference portion. Display unevenness may occur at the periphery edge of a screen because local stress is added to the image display panel immediately below the printing level difference portion through the pressure sensitive adhesive, so that the peripheral edge of the screen is dynamically distorted.

For solving problems caused by a printing level difference of a front transparent member as described above, a soft and thick pressure sensitive adhesive sheet is used for bonding the front transparent plate, so that level difference absorbency is imparted. For example, in JP-A-2012-237965 and JP-A-2014-115468, a pressure sensitive adhesive layer with storage elastic modulus being adjusted within specific range is used for bonding an optical film arranged on a surface of the image display panel and a front transparent plate, so that level difference absorbency is imparted. JP-A-2014-115468 describes a method in which an ultraviolet curable pressure sensitive adhesive is used for bonding an image display panel and a front transparent plate. Since the pressure sensitive adhesive before curing has low storage elastic modulus, generation of bubbles in the vicinity of a printing level difference during bonding is suppressed. The pressure sensitive adhesive is cured after the bonding to improve long-term reliability of adhesion.

### SUMMARY OF THE INVENTION

### Problems to be Solved by the Invention

When an ultraviolet curable pressure sensitive adhesive is used as an interlayer filler for bonding an image display panel and a front transparent plate to each other as described above, both level difference absorbency during bonding and reliability of adhesion after bonding can be secured. However, the inventors have found that level difference absorbency during bonding of the optical film to a front transparent plate is sometimes insufficient and designed properties is not exhibited when an optical film with an ultraviolet curable pressure sensitive adhesive layer is used in production of an image display device. Level difference absorbency tends to be particularly reduced when an optical film with a pressure sensitive adhesive on both sides having a pressure sensitive adhesive layer on each of both surfaces of an optical film is used and the optical film and a front transparent plate are bonded to each other with an ultraviolet curable pressure sensitive adhesive layer interposed therebetween after the optical film and an image display cell are bonded to each other with a pressure sensitive adhesive layer interposed therebetween.

In view of the above, an object of the present invention is to provide an ultraviolet curable pressure sensitive adhesive sheet and an optical film with a pressure sensitive adhesive in which level difference absorbency is hardly reduced in manufacturing process of an image display device before bonding.

### Means for Solving the Problems

The inventors have found that curing of the pressure sensitive adhesive progresses even when an ultraviolet irradiation is not performed, and the storage elastic modulus increases as compared to the pressure sensitive adhesive sheet immediately after production. As a result of studies on a cause of progress of the curing, it has been learned that curing of the pressure sensitive adhesive may progress due to long-time exposure to a very weak ultraviolet ray from a fluorescent lamp etc. in manufacturing environment. It has been found that progress of ultraviolet ray curing before bonding can be suppressed by providing an ultraviolet shielding protective sheet on a surface of the pressure sensitive adhesive sheet.

A pressure sensitive adhesive sheet according to the present invention includes a first pressure sensitive adhesive layer with a first protective sheet releasably attached to one surface thereof. The first pressure sensitive adhesive layer contains an Ultraviolet curable pressure sensitive adhesive, and the first protective sheet has a transmittance of 1% or less to an ultraviolet ray with a wavelength of 360 nm. Preferably, the first pressure sensitive adhesive layer has a thickness of 45 μm or more. Preferably, the first pressure sensitive adhesive layer has a storage elastic modulus of 1×10² Pa to 5×10⁴ Pa at 80° C. The storage elastic modulus of the first pressure sensitive adhesive layer at 80° C. after irradiation with an ultraviolet ray is larger than that before irradiation with the ultraviolet ray The storage elastic modulus at 80° C. after irradiation with an ultraviolet ray is preferably 1.2 or more times as large as that before irradiation with the ultraviolet ray.

The present invention also relates to an optical film with a pressure sensitive adhesive, which includes the pressure sensitive adhesive sheet on a first main surface of the optical film. Specifically; the optical film with a pressure sensitive adhesive according to the present invention includes the first pressure sensitive adhesive layer on a first main surface of the optical film, and the first protective sheet releasably attached on the first pressure sensitive adhesive layer.

One embodiment of the present invention is an optical film with a pressure sensitive adhesive on both sides, which further includes a second pressure sensitive adhesive layer on a second main surface of the optical film and a second protective sheet on the second pressure sensitive adhesive layer. Preferably, the second pressure sensitive adhesive layer has a thickness of 38 μm or less. Preferably, the second pressure sensitive adhesive layer includes a non-ultraviolet curable pressure sensitive adhesive. Preferably, the second protective sheet has a transmittance of 5% or more to an ultraviolet ray with a wavelength of 360 nm.

The present invention also relates to a method for producing an image display device using the optical film with a pressure sensitive adhesive on both sides. The image display device includes a front transparent plate or a touch panel, an optical film including a polarizing plate, and an image display cell in this order from the viewing-side. In the method for producing an image display device according to the present invention, the second protective sheet is separated from the optical film with a pressure sensitive adhesive on both sides, and the optical film and the image display cell are bonded to each other with the second pressure sensitive adhesive layer interposed therebetween (cell-side bonding step). Thereafter, the first protective sheet is separated, and the optical film and the front transparent plate or the touch panel are bonded to each other with the first pressure sensitive adhesive layer interposed therebetween (viewing-side bonding step). Thereafter, an ultraviolet ray is applied from the viewing-side to cure the first pressure sensitive adhesive layer (front curing step).

In the pressure sensitive adhesive sheet according to the present invention, the pressure sensitive adhesive is an ultraviolet curable pressure sensitive adhesive. By using an ultraviolet curable pressure sensitive adhesive as an interlayer filler for bonding an image display panel and a front transparent member such as a front transparent plate or a touch panel to each other, fluidity is improved to secure level difference absorbency during bonding, and by performing ultraviolet curing after bonding, reliability of adhesion is improved. The protective sheet releasably attached to the pressure sensitive adhesive has an ultraviolet shielding property, and therefore even when the pressure sensitive adhesive layer is exposed to an ultraviolet ray for a long time in manufacturing environment, progress of a curing before bonding is suppressed, so that level difference absorbency can be maintained.

### BRIEF DESCRIPTION OF THE DRAWINGS

FIG. 1 is a cross sectional view showing one embodiment of a pressure sensitive adhesive sheet;

FIG. 2 is a cross sectional view showing one embodiment of an optical film with a pressure sensitive adhesive;

FIG. 3 is a cross sectional view showing one embodiment of an optical film with a pressure sensitive adhesive on both sides;

FIG. 4 is a cross sectional view showing one embodiment of an image display device; and

FIG. 5 is a graph showing a time-dependent change in cured rate of the pressure sensitive adhesive when the pressure sensitive adhesive sheet is left standing under fluorescent lamp illumination.

### DESCRIPTION OF EMBODIMENTS

[Pressure Sensitive Adhesive Sheet]

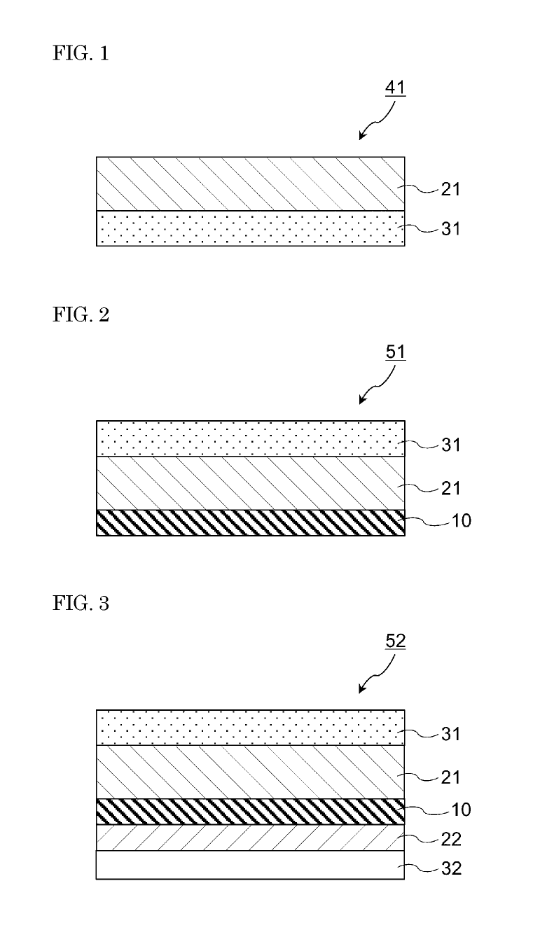

FIG. 1 is a schematic sectional view showing one embodiment of a pressure sensitive adhesive sheet according to the present invention. A pressure sensitive adhesive sheet 41 includes a protective sheet 31 on one surface of a first pressure sensitive adhesive layer 21. The protective sheet 31 is releasably attached on the pressure sensitive adhesive layer 21. Other protective sheet, an optical film 10 or the like may be bonded to a surface on a side opposite to a surface of the pressure sensitive adhesive layer 21 which is attached with the protective sheet 31 (see FIGS. 2 and 3).

<First Pressure Sensitive Adhesive Layer>

The first pressure sensitive adhesive layer 21 is preferably used for bonding an image display panel to a front transparent member such as a front transparent plate or a touch panel. The pressure sensitive adhesive layer 21 contains an ultraviolet curable pressure sensitive adhesive. The ultraviolet curable pressure sensitive adhesive has a small storage elastic modulus before curing, and therefore generation of bubbles in the vicinity of a printing level difference in the front transparent member in bonding to the front transparent member, and display unevenness on the peripheral edge region of the image display device can be suppressed. By performing ultraviolet curing after bonding to the front transparent member, reliability of adhesion is improved.

By irradiating the ultraviolet curable pressure sensitive adhesive with an ultraviolet ray; a base polymer is crosslinked by a polymerizable compound to increase the storage elastic modulus of the pressure sensitive adhesive. While the composition of the ultraviolet curable pressure sensitive adhesive is not particularly limited, the ultraviolet curable pressure sensitive adhesive generally contains a base polymer and a polymerizable compound. The polymerization curing method by irradiation with an ultraviolet ray may be any of a radical type, a cationic type and an anionic type. The polymerization may be a photoinduced alternating copolymerization, which does not involve an initiator. A hybrid type in which the above-mentioned types of methods are combined may also be used. A radical type or a cationic type is commonly used.

The polymerizable compound may be made of various kinds of compounds such as polyester-based, acryl-based, urethane-based, amide-based, silicone-based and epoxy-based compounds, which include ultraviolet curable monomers, oligomers and prepolymers. The polymerizable compound is preferably one having an ultraviolet polymerizable functional group, particularly preferably one containing an acryl-based monomer or oligomer component having two or more such functional groups. The two or more polymerizable functional groups may be the same, or different. Examples of the ultraviolet curable acryl-based compound include polyfunctional acrylates, epoxy acrylates, urethane acrylates, polyester acrylates, polyether acrylates and spiroacetal-based acrylates. The polymerizable compound may be present in a pressure sensitive adhesive composition, or may be bonded to a functional group such as a hydroxy group of the base polymer.

Preferably, the ultraviolet curable pressure sensitive adhesive contains a photopolymerization initiator. The photopolymerization initiator generates a radical, an acid, a base or the like when irradiated with an ultraviolet ray, and can be appropriately selected according to, for example, the type of the polymerizable compound. A photoradical generator is preferably used for photoradical polymerization, a photoacid generator is preferably used for photocationic polymerization, and a photobase generator is preferably used for photoanionic polymerization. As the photoradical generator, a compound having one or more radical generation points in the molecule is used, and examples thereof include hydroxyketones, benzyl dimethyl ketals, aminoketones, acylphosphine oxides, benzophenones and trichloromethyl-containing triazine derivatives.

The base polymer of the ultraviolet curable pressure sensitive adhesive is not particularly limited, an acryl-based polymer, a silicone-based polymer, a polyester, a polyurethane, a polyamide, a polyvinyl ether, a vinyl acetate/vinyl chloride copolymer, a modified polyolefin, an epoxy-based polymer, a fluorine-based polymer, or a polymer based on a rubber such as a natural rubber or a synthetic rubber can be appropriately selected and used. A pressure sensitive adhesive excellent in optical transparency is preferable for the pressure sensitive adhesive layer, because it is used for bonding a front transparent member in an image display device. Specifically, it is preferred that the pressure sensitive adhesive layer 21 has a haze of 1.0% or less, and a total light transmittance of 90% or more.

As a pressure sensitive adhesive excellent in optical transparency and adhesiveness, an acryl-based pressure sensitive adhesive containing an acryl-based polymer as a base polymer is preferably used. In the acryl-based pressure sensitive adhesive, the content of the acryl-based base polymer based on the total amount of solid components in the pressure sensitive adhesive composition is preferably 50% by weight or more, more preferably 70% by weight or more, further preferably 60% by weight or more.

As the acryl-based polymer, one having a monomer unit of a (meth)acrylic acid alkyl ester as a main skeleton is suitably used. In this specification, the “(meth)acryl” means acryl and/or methacryl. As the (meth)acrylic acid alkyl ester, a (meth)acrylic acid alkyl ester with the alkyl group having 1 to 20 carbon atoms is preferably used. The content of the (meth)acrylic acid alkyl ester is preferably 40% by weight or more, more preferably 50% by weight or more, further preferably 60% by weight or more based. on the total amount of monomer components that form the base polymer. The acryl-based base polymer may be a copolymer of a plurality of (meth)acrylic acid alkyl esters. The arrangement of constituent monomer units may be random, or blockwise.

The acryl-based base polymer preferably contains an acryl-based monomer unit having a crosslinkable functional group as a copolymer component. When the base polymer contains a crosslinkable functional group, ultraviolet cure can be easily performed. Examples of the acryl-based monomer having a crosslinkable functional group include hydroxy group-containing monomers and carboxy group-containing monomers. Particularly, it is preferred that a hydroxy group-containing; monomer is contained as the copolymer component of the base polymer. When the base polymer has a hydroxy group-containing monomer as a monomer unit, the crosslinkability of the base polymer is improved, and cloudiness of the pressure sensitive adhesive under a high-temperature and high-humidity environment tends to be suppressed, so that a pressure sensitive adhesive having high transparency is obtained.

Preferably; the acryl-based base polymer contains, in addition to the above mentioned (meth)acrylic acid alkyl ester and hydroxy group-containing monomer unit, a monomer unit having high polarity, such as a nitrogen-containing monomer. When the acryl-based base polymer contains a high-polarity monomer unit such as a nitrogen-containing monomer unit in addition to a hydroxy group-containing monomer unit, the pressure sensitive adhesive has high adhesiveness and retentive strength, and cloudiness under a high-temperature and high-humidity environment is suppressed.

The acryl-based polymer as a base polymer can be obtained by polymerizing the monomer components using various kinds of known methods such as solution polymerization, emulsification polymerization and mass polymerization. The solution polymerization method is suitable from the viewpoint of a balance of properties such as adhesive strength and retentive strength of the pressure sensitive adhesive, costs and so on.

A crosslinked structure may be introduced in the base polymer of the ultraviolet curable pressure sensitive adhesive. The crosslinked structure is formed by, for example, adding a crosslinker after polymerization of the base polymer. As the crosslinker, a common cross linker can be used, such as an isocyanate-based crosslinker, an epoxy-based cross:Linker, an oxazoline-based crosslinker, an aziridine-based crosslinker, a carbodiimide-based crosslinker or a metal chelate-based crosslinker. By mixing, with the base polymer, a radical-polymerizable compound having a functional group capable of being chemically bonded to a functional group of the base polymer and a radical-polymerizable functional group, the radical-polymerizable functional group can be introduced into the base polymer. As the functional group capable of being chemically bonded to a functional group of the base polymer, an isocyanate group is preferable. The isocyanate group forms a urethane bond with a hydroxy group of the base polymer, so that a radical-polymerizable functional group can be easily introduced into the base polymer.

The pressure sensitive adhesive composition may contain a silane coupling agent and a tackifier in order to adjust the adhesive strength. The pressure sensitive adhesive composition may contain additives such as a plasticizer, a softener, a degradation inhibitor, a filler, a colorant, an antioxidant, a surfactant and an antistatic agent.

The pressure sensitive adhesive layer 21 may be a single layer, or may have a multilayered structure in which a plurality of pressure sensitive adhesive layers are laminated. When the pressure sensitive adhesive layer 21 has a multilayered structure, at least one layer is an ultraviolet curable pressure sensitive adhesive layer, but it is preferred that all the layers are ultraviolet curable pressure sensitive adhesive layers.

The thickness of the pressure sensitive adhesive layer 21 is preferably 45 μm or more, more preferably 60 μm or more, further preferably 70 μm or more. When the thickness of the pressure sensitive adhesive layer falls within the above-mentioned range, level difference absorbency to a level difference in a printed portion of the front transparent member can be imparted in bonding to the front transparent member such as a touch panel or a front transparent plate. The upper limit of the thickness of the pressure sensitive adhesive layer 21 is not particularly limited, but is preferably 500 μm or less, more preferably 300 μm or less, further preferably 250 μm or less, from the viewpoint of lightening/thinning of the image display device and in view of ease of forming the pressure sensitive adhesive layer, and handling characteristics.

At the time when the front transparent member and the optical film are bonded to each other with the pressure sensitive adhesive layer interposed therebetween, the bonding is generally performed under a heating environment, and a pressurization/heating treatment is often performed by an autoclave for the purpose of removal of bubbles, etc. Preferably the pressure sensitive adhesive layer 21 has high fluidity at the time of bonding the optical film to the front transparent member. Therefore, the storage elastic modulus G′_{80° C.} of the pressure sensitive adhesive layer 21 at 80° C. is preferably 5×10⁴ Pa or less, more preferably 3×10 Pa or less, further preferably 1×10⁴ Pa or less. For suppressing protrusion of the pressure sensitive adhesive from an end surface under a heating environment, the storage elastic modulus G′_{80° C.} of the pressure sensitive adhesive layer 21 before curing is preferably 1×10² Pa or more, more preferably 3×10² Pa or more, further preferably 5×10² Pa or more. The storage elastic modulus G′ is determined by reading a value at a predetermined temperature in measurement performed at a temperature elevation rate of 5° C./minute in a range of −50 to 150° C. under the condition of a frequency of 1 Hz in accordance with the method described in JIS K 7244-1 “Plastics—Determination of Dynamic Mechanical Properties”.

Since the pressure sensitive adhesive layer 21 contains an ultraviolet curable pressure sensitive adhesive, curing is caused to progress by irradiation with an ultraviolet ray, so that the storage elastic modulus increases. Accordingly, even when exposed to a heating environment in actual use of the image display device, the pressure sensitive adhesive is inhibited from flowing, so that failures such as recurrence of bubbles (delay bubbles) and peeling of the pressure sensitive adhesive layer are suppressed, and thus long-term-reliable adhesiveness can be achieved.

For securing adhesiveness and fluidity during bonding as well as reliability of adhesion after formation of the image display device, the storage elastic modulus G′_{80° C.} of the pressure sensitive adhesive layer 21 at 80° C. after UV-curing is preferably 1×10³ Pa to 1×10⁶ Pa, more preferably 3×10³ Pa to 7×10⁵ Pa, further preferably 5×10³ Pa to 5×10⁵ Pa. The storage elastic modulus G′_{80° C.} of the pressure sensitive adhesive layer 21 after UV-curing is preferably 1.2 or more times, more preferably 1.5 or more times, further preferably 2 or more times, especially preferably 3 or more times as large as the storage elastic modulus G′_{80° C.} of the pressure sensitive adhesive layer 21 before curing. The storage elastic modulus after UV-curing is measured by the above-mentioned method using as a sample a pressure sensitive adhesive layer irradiated with an ultraviolet ray with an integrated light amount of 10 J/cm².

<First Protective Sheet>

First protective sheet 31 is releasably attached on the first pressure sensitive adhesive layer 21. The protective sheet 31 is provided for protecting the exposed surfaces of the pressure sensitive adhesive layer 21, until the pressure sensitive adhesive is bonded to the front transparent member or the like. The protective sheet 31 is an ultraviolet shielding sheet, and has a transmittance of 1% or less to an ultraviolet ray with a wavelength of 360 nm. The protective sheet 31 can be made to have an ultraviolet transmittance of 1% or less by imparting ultraviolet absorbency and ultraviolet reflectivity to the protective sheet 31. The transmittance of the protective sheet 31 to an ultraviolet ray with a wavelength of 360 nm is preferably 0.5% or less, more preferably 0.3% or less. The transmittance of the protective sheet 31 to an ultraviolet ray with a wavelength of 380 nm is preferably 3% or less, more preferably 2% or less.

When the protective sheet 31 has an ultraviolet shielding property, UV-curing of the pressure sensitive adhesive layer 21 can be suppressed even if the pressure sensitive adhesive sheet 41 is exposed to an ultraviolet ray from a fluorescent lamp etc. for a long time in, for example, manufacturing environment of an image display device. When the protective sheet 31 is separated immediately before the bonding of pressure sensitive adhesive layer 21 and the front transparent plate etc. the storage elastic modulus of the pressure sensitive adhesive layer 21 is kept low in the bonding, so that generation of bubbles in the vicinity of the printing level difference and occurrence of display unevenness at the peripheral edge of a screen can be suppressed. The ultraviolet shielding protective sheet 31 is separated from the surface of the pressure sensitive adhesive layer 21 in bonding, and therefore when an ultraviolet ray is applied after the bonding, the storage elastic modulus of the pressure sensitive adhesive layer 21 is increased by UV-curing, so that adhesion reliability can be improved.

Examples of the constituent material of the protective sheet 31 include plastic films, porous materials such as paper, cloth and nonwoven fabrics, and appropriate thin foliated materials such as nets, foamed sheets, metal foils and laminates thereof and plastic films are suitably used in view of transparency and surface smoothness.

The plastic film is not particularly limited as long as it is a film capable of protecting the surface of the pressure sensitive adhesive layer, and examples thereof include polyethylene films, polypropylene films, polybutene films, polybutadiene films, polymethylpentene films, polyvinyl chloride films, vinyl chloride copolymer films, polyethylene terephthalate films, polybutylene terephthalate films, polyurethane films and ethylene-vinyl acetate copolymer films. Particularly, a polyester-based film such as polyethylene terephthalate film and polybutylene terephthalate film is preferably used because it is excellent in transparency and mechanical characteristics.

By applying an ultraviolet absorbing coating or an ultraviolet reflecting coating to the film surface, or incorporating an ultraviolet absorber in the film, an ultraviolet shielding property can be imparted to the plastic film. Examples of the ultraviolet absorber include benzotriazole-based ultraviolet absorbers, benzophenone-based ultraviolet absorbers, salicylate-based ultraviolet absorbers, triazine ultraviolet absorbers and cyanoacrylate-based ultraviolet absorbers.

The thickness of the protective sheet provided on the surface of the pressure sensitive adhesive layer is normally about 5 to 200 μm, preferably about 10 to 150 μm. The thickness of the protective sheet 31 is preferably 45 μm to 130 μm. When the thickness of the protective sheet is in this range, warpage of the film tends to be suppressed when an optical film with a pressure sensitive adhesive on both sides as shown in FIG. 3 is prepared.

The protective sheet may be subjected to release and antifouling treatments with a silicone-based, fluorine-based, long-chain alkyl-based or fatty acid amide-based releasing agent, a silica powder or the like, and an antistatic treatment of coating type, kneading type, vapor deposition type or the like. Particularly; by appropriately subjecting the surface of the protective sheet to a release treatment with using silicone, long-chain alkyl, fluorine or the like, releasability from the pressure sensitive adhesive layer 21 can be further improved. The peel strength between the pressure sensitive adhesive layer 21 and the protective sheet 31 is preferably 0.8 N/50 mum or less. The peel strength between a pressure sensitive adhesive layer 22 and a protective sheet 32 as described later is preferably 0.8 N/50 mm or less.

Preferably; the protective sheet 31 has high transparency in a visible light region for facilitating visual inspection and optical inspection of a product. The transmittance of the protective sheet 31 to visible light is preferably 50% or more, more preferably 60% or more, further preferably 70% or more.

<Method for Forming Pressure Sensitive Adhesive Sheet>

The method for forming a pressure sensitive adhesive sheet with the protective sheet 31 releasably attached to the pressure sensitive adhesive layer 21 is not particularly limited. Examples thereof include a method in which a pressure sensitive adhesive composition is applied onto the protective sheet 31, dried to remove a solvent etc., and subjected to a crosslinking treatment as necessary to form the pressure sensitive adhesive layer 21; a method in which the pressure sensitive adhesive layer 21 is formed on other film such as an optical film, and the protective sheet 31 is bonded to the exposed surface of the pressure sensitive adhesive layer 21; and a method in which a pressure sensitive adhesive layer is formed on other film, and the pressure sensitive adhesive layer is transferred onto the protective sheet 31.

As the method for forming the pressure sensitive adhesive layer, various kinds of methods are used. Specific examples include roll coating, kiss roll coating, gravure coating, reverse coating, roll brushing, spray coating, dip roll coating, bar coating, knife coating, air knife coating, curtain coating, lip coating, and extrusion coating methods using a die coater etc. Among them, use of a die coater is preferred, and in particular, use of a die coater using a fountain die or a slot die is more preferred.

As a method for drying the applied pressure sensitive adhesive, a suitable method can be appropriately employed according to a purpose. The heating/drying temperature is preferably 40° C. to 200° C., more preferably 50° C. to 180° C., further preferably 70° C. to 170° C. The drying time is preferably 5 seconds to 20 minutes, more preferably 5 seconds to 15 minutes, further preferably 10 seconds to 10 minutes.

[Optical Film with Pressure Sensitive Adhesive]

The pressure sensitive adhesive sheet according to the present invention can be used in the form of an optical film with a pressure sensitive adhesive in which the optical film 10 is bonded to a surface of the first pressure sensitive adhesive layer 21 on a side opposite to a surface attached with the first protective sheet 31 as shown in FIGS. 2 and 3. In practical use of the optical film with a pressure sensitive adhesive, the protective sheet 31 is separated from the surface of the pressure sensitive adhesive layer 21, and the optical film 10 is bonded to other member with the pressure sensitive adhesive layer 21 interposed therebetween.

An optical film with a pressure sensitive adhesive 51 as shown in FIG. 2 includes the pressure sensitive adhesive sheet 41 on the first main surface of the optical film 10. Specifically in the optical film with a pressure sensitive adhesive 51, the first pressure sensitive adhesive layer 21 is provided on the first main surface of the optical film 10, and the first protective sheet 31 is releasably attached thereon.

FIG. 3 shows an optical film with a pressure sensitive adhesive on both sides 52 in which the pressure sensitive adhesive sheet 41 is provided on the first main surface of the optical film 10, the second pressure sensitive adhesive layer 22 is provided on the second main surface of the optical film 10, and the second protective sheet 32 is releasably attached thereon. In the optical film with a pressure sensitive adhesive on both sides, the first main surface provided with the first pressure sensitive adhesive layer 21 is a surface which is on the viewing-side during formation of an image display device, and the first pressure sensitive adhesive layer 21 is used for bonding the optical film 10 to the front transparent member 70 such as a front transparent plate or a touch panel. The second main surface provided with the second pressure sensitive adhesive layer 22 is a surface which disposed on the side of an image display cell 60 such as a liquid crystal cell or an organic EL cell during formation of an image display device, and the second pressure sensitive adhesive layer 22 is used for bonding the optical film 10 to the image display cell 60.

<Optical Film>

Example of the optical film 10, includes one having a polarizing plate. As the polarizing plate, one having an appropriate transparent protecting film laminated on one surface or both surfaces of a polarizer as necessary is generally used. The polarizer is not particularly limited, and various kinds of polarizers may be used. Examples of the polarizer include films obtained by impregnating a dichroic material such as iodine or a dichroic dye into a hydrophilic polymer film such as a polyvinyl alcohol-based film, a partially formalized polyvinyl alcohol-based film or an ethylene-vinyl acetate copolymer-based partially saponified film, and uniaxially stretching the film; and polyene-based oriented films such as those of dehydrated products of polyvinyl alcohol and dehydrochlorinated products of polyvinyl chloride.

For the transparent protecting film as a protecting film for the polarizer, a resin excellent in transparency, mechanical strength, thermal stability, moisture barrier property and optical isotropy, such as a cellulose-based resin, a cyclic polyolefin-based resin, an acryl-based resin, a phenylmaleimide-based resin or a polycarbonate-based resin, is preferably used. When a transparent protecting film is provided on each of both surfaces of the polarizer, protecting films formed of the same polymer material may be used or protecting films formed of different polymer materials may be used on the front surface and the back surface. For the purpose of for example, optical compensation and wide viewing of a liquid crystal cell, an optically anisotropic film such as a retardation sheet (stretched film) can also be used as a protecting film for the polarizer.

In the optical film 10, retardation sheets, wide-viewing films, viewing angle restriction (peep prevention) films, brightness enhancement films and the like may be laminated on one surface or both surfaces of the polarizing plate with an appropriate adhesive layer or a pressure sensitive adhesive layer interposed therebetween as necessary A surface of the optical film 10 may be provided with a hard coat layer, or subjected to an antireflection treatment, or a treatment intended for prevention of sticking, diffusion or antiglare.

<Second Pressure Sensitive Adhesive Layer>

In the embodiment shown in FIG. 3, a second pressure sensitive adhesive layer 22 is provided on the second main surface of the optical film 10. The thickness of the second pressure sensitive adhesive layer 22 is preferably 38 μm or less, more preferably 10 μm to 35 μm, further preferably 13 μm to 30 μm. When the thickness of the second pressure sensitive adhesive layer falls within the above-mentioned range, excellent durability can be secured, and defects such as ingress of bubbles can be suppressed.

For the second pressure sensitive adhesive layer, various kinds of pressure sensitive adhesives that are used for bonding the optical film and the image display cell to each other can be used. As the pressure sensitive adhesive that forms the second pressure sensitive adhesive layer, an acryl-based pressure sensitive adhesive is preferably used. It is preferred that the second pressure sensitive adhesive layer has lower fluidity than the first pressure sensitive adhesive layer.

The storage elastic modulus G′ of the second pressure sensitive adhesive layer 22 at 25° C. is preferably 1×10⁴ Pa to 1×10⁷ Pa, more preferably 3×10⁴ Pa to 5×10⁶ Pa, further preferably 5×10 Pa to 1×10⁶ Pa. When the storage elastic modulus of the second pressure sensitive adhesive layer falls within the above-mentioned range, moderate adhesiveness is exhibited. In addition, fluidization of the second pressure sensitive adhesive layer is suppressed at the time when the optical film 10 and the front transparent member 70 are bonded to each other with the first pressure sensitive adhesive layer 21 interposed therebetween by heating, so that contamination of other members and the inside of the bonding device can be suppressed.

Preferably the second pressure sensitive adhesive layer 22 is a non-ultraviolet curable pressure sensitive adhesive layer, the storage elastic modulus of which is not increased even by irradiation with an ultraviolet ray. Specifically, the storage elastic modulus G′_{80° C.} after irradiation with an ultraviolet ray with an integrated light amount of 10 J/cm² is preferably less than 1.2 times as large as that before irradiation with the ultraviolet ray. When the second pressure sensitive adhesive layer is a non-ultraviolet curable layer, the bonding step of bonding the optical film and the image display cell with the second pressure sensitive adhesive layer 22 interposed therebetween can be simplified because irradiation with an ultraviolet ray after bonding is not required.

<Second Protective Sheet>

The second protective sheet 32 is releasably attached to the surface of the second pressure sensitive adhesive layer 22. The protective sheet 32 is used for the purpose of protecting the exposed surface of the pressure sensitive adhesive layer 22 until the pressure sensitive adhesive layer is bonded to the image display cell. As the second protective sheet 32, one similar to the first protective sheet 31 can be used. The thickness of the protective sheet 32 is preferably 30 μm to 55 μm. The thickness of the protective sheet 32 is preferably smaller than the thickness of the protective sheet 31. When the thickness of the protective sheet is in this range, warpage of the optical film with a pressure sensitive adhesive on both sides tends to be suppressed.

The second protective sheet 32 is not required to have an ultraviolet shielding property in the manufacturing environment of an image display device, the optical film with a pressure sensitive adhesive 52 may be exposed to an ultraviolet ray from the second protective sheet 32 side, but the polarizer protecting film etc. included in the optical film 10 generally has ultraviolet absorbency and therefore an ultraviolet ray from the second protective sheet 32 side hardly arrives at the first pressure sensitive adhesive layer 21. Accordingly, even when the second protective sheet 32 has an ultraviolet transmitting property, UV-curing of the first pressure sensitive adhesive layer 21 can be suppressed.

When the second protective sheet 32 has an ultraviolet transmitting property; contamination of the second pressure sensitive adhesive layer 22 clue to bleed-out of an ultraviolet absorber from the protective sheet can be suppressed. When ultraviolet absorbency is imparted to the film by adding an ultraviolet absorber, the visible light transmittance tends to decrease, but the ultraviolet transmitting film has a high visible light transmittance. Accordingly, visual inspection and optical inspection of a product can be easily performed. The second pressure sensitive adhesive layer 22 is a layer disposed between the image display cell 60 and the optical film (polarizing plate) 10 in the image display device, and therefore defects etc. in the layer more significantly affect displayed image as compared to the first pressure sensitive adhesive layer 21 disposed on the outside of the image display panel. Accordingly, it is preferred that the second protective sheet 32 attached on the second pressure sensitive adhesive layer 22 is made to have an ultraviolet transmitting property, so that contamination of the pressure sensitive adhesive layer due to bleed-out of an ultraviolet absorber etc. is prevented, and optical inspection accuracy is improved. The transmittance of the second protective sheet 32 to an ultraviolet ray with a wavelength of 360 nm is preferably 5% or more, more preferably 10% or more.

[Image Display Device]

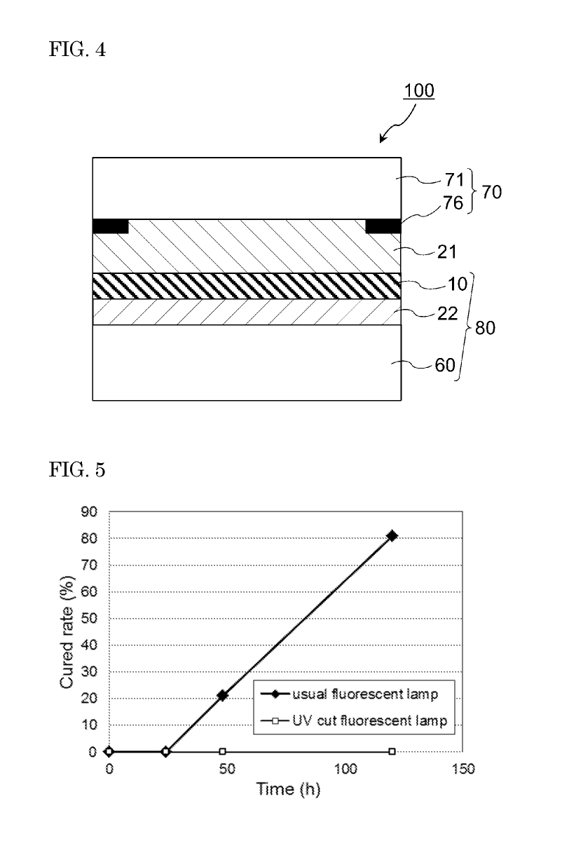

The optical film with a pressure sensitive adhesive on both sides 52 is suitably used for formation of the image display device 100 which includes the image display cell 60 such as a liquid crystal cell or an organic EL cell on one surface of the optical film 10 including a polarizing plate, and includes the front transparent member 70 such as a touch panel or a front transparent plate on the other surface (viewing-side) as schematically shown in FIG. 4. In the image display device, the front transparent member 70 is bonded to the optical film 10 with the first pressure sensitive adhesive layer 21 interposed therebetween, and the image display cell 60 is bonded to the optical film 10 with the second pressure sensitive adhesive layer 22 interposed therebetween.

The front transparent member 70 is, for example, a front transparent plate (window layer) or a touch panel. As the front transparent plate, a transparent plate having appropriate mechanical strength and thickness is used. As this transparent plate, for example, a transparent resin plate such as that of an acryl-based resin or a polycarbonate-based resin, or a glass plate is used. As the touch panel, a touch panel of any type such as resistive film type, capacitance type, optical type or ultrasonic type is used.

As the optical film with a pressure sensitive adhesive 52, one cut to a product size consistent with an image display size in advance is suitably used in formation of the image display device. The method for bonding the image display cell 60 to the optical film with a pressure sensitive adhesive 52, and the method for bonding the front transparent member 70 to the optical film with a pressure sensitive adhesive 52 are not particularly limited, and bonding can be performed by various kinds of known methods after the protective sheets 31 and 32 attached on the surfaces of the first pressure sensitive adhesive layer 21 and the second pressure sensitive adhesive layer 22, respectively; are peeled off.

The order of bonding is not particularly limited, bonding of the image display cell. GO to the first pressure sensitive adhesive layer 21 of the optical film with a pressure sensitive adhesive 52 may precede, or bonding of the front transparent member 70 to the second pressure sensitive adhesive layer 22 of the optical film with a pressure sensitive adhesive 52 may precede. The former bonding and the latter bonding may be performed in parallel. For improving workability in bonding and the axis precision of the optical film, it is preferred that the optical film is bonded to the front transparent member 70 with the first pressure sensitive adhesive layer 21 interposed therebetween (viewing-side bonding) after the optical film is bonded to the image display cell 60 with the second pressure sensitive adhesive layer 22 interposed therebetween (cell-side bonding). In the bonding, the protective sheets 31 and 32 attached on the surfaces of the pressure sensitive adhesive layers 21 and 22 are peeled off and removed beforehand.

When the optical film is bonded to the front transparent member 70 with the first pressure sensitive adhesive layer 21 interposed therebetween after the optical film is bonded to the image display cell 60 with the second pressure sensitive adhesive layer 22 interposed therebetween, the first pressure sensitive adhesive layer is exposed for a longer time under an illumination environment including UV light in manufacturing environment as compared to a case where bonding of only one surface is performed. Accordingly, generally UV curing of the first pressure sensitive adhesive layer 21 easily progresses. On the other hand, in the present invention, the first protective sheet 31 has an ultraviolet shielding property, and therefore even when the first pressure sensitive adhesive layer 21 is exposed for a long time under an illumination environment including UV light, UV-curing of the first pressure sensitive adhesive layer 21 before bonding can be suppressed.

It is preferred to perform degassing for removing bubbles at the interface between the first pressure sensitive adhesive layer 21 and the front transparent member 70, and in the vicinity of a non-flat portion such as the printed portion 76 on the front transparent member 70 after the optical film and the front transparent member are bonded to each other. As a degassing method, an appropriate method such as heating, pressurization or pressure reduction can be employed. For example, it is preferred that bonding is performed while ingress of bubbles is suppressed under reduced pressure and heating, and pressurization is then performed in parallel with heating through autoclave or the like for the purpose of, for example, suppressing delay bubbles. Here, since the first pressure sensitive adhesive layer 21 is not UV-cured yet, and thus the fluidity of the pressure sensitive adhesive is high, the pressure sensitive adhesive easily follows the shape of a non-flat portion such as a level difference, so that bubbles are easily removed.

When degassing is performed by heating, the heating temperature is in a range of generally about 30° C. to 150° C., preferably 40° C. to 130° C., more preferably 50° C. to 120° C., further preferably 60° C. to 100° C. When pressurization is performed, the pressure is in a range of generally about 0.05 MPa to 2 MPa, preferably 0.1 MPa to 1.5 MPa, more preferably 0.2 MPa to 1 MPa.

After the optical film 10 and the front transparent member 70 are bonded to each other, the first pressure sensitive adhesive layer 21 is UV-cured (front curing). The UV-curing can be performed by irradiating the first pressure sensitive adhesive layer 21 with an ultraviolet ray from the front transparent member 70 side. The pressure sensitive adhesive is cured to improve adhesion reliability between the optical film 10 and the front transparent member 70 in the image display device.

### EXAMPLES

The present invention will be described more specifically below by showing examples and comparative examples, but the present invention is not limited to these examples.

[Preparation of Viewing-Side Pressure Sensitive Adhesive Sheet]

### (Preparation of Base Polymer)

70 parts by weight of 2-ethylhexyl acrylate (2EHA), 15 parts by weight of N-vinylpyrrolidone (NVP) and 15 parts by weight of hydroxyethyl acrylate (HEA) as monomer components, 0.2 part by weight of AIBN as a thermopolymerization initiator, 0.12 part by weight of α-thioglycerol (TGR) as a chain-transfer agent, and 233 parts by weight of ethyl acetate were put into a separable flask provided with a thermometer, a stirrer, a cooling tube and a nitrogen gas inlet. Nitrogen purge was performed for 1 hour while the mixture was stirred under nitrogen atmosphere at 23° C. Thereafter, the mixture was reacted at 65° C. for 5 hours and then reacted at 70° C. for 2 hours to obtain an acryl-based base polymer solution.

(Preparation of Ultraviolet Curable Pressure Sensitive Adhesive Composition)

The following components were added to the obtained acryl-based base polymer solution, based on 100 parts by weight of the base polymer: 7 parts by weight of polypropylene glycol (#400) diacrylate (trade name: NK ESTER APG-400 manufactured by SHIN-NAKAMURA CHEMICAL CO., LTD.) as a difunctional acrylate having an ether bond; 0.3 part by weight of a trimethylolpropane adduct of xylylene diisocyanate (trade name: TAKENATE D110N manufactured by Mitsui Chemicals, Incorporated) as an isocyanate-based crosslinker; and 0.1 part by weight of 2,2-dimethoxy-1,2-diphenylethane-1-one (trade name: IRGACURE 651 manufactured by BASF Ltd.) as a photopolymerization initiator. The mixture was uniformly mixed to prepare an ultraviolet curable pressure sensitive adhesive composition.

(Preparation of Pressure Sensitive Adhesive Sheet)

The pressure sensitive adhesive composition was applied onto a release-treated surface of a 75 μm-thick separator so as to have a thickness of 150 μm after drying, dried at 100° C. for 3 minutes to remove the solvent, and then crosslinked through an aging treatment in an atmosphere at 25° C. for 3 days to obtain a pressure sensitive adhesive sheet. As separators, three polyethylene terephthalate (PET) films having different ultraviolet transmittances (A and B: ultraviolet absorbing films; C: ultraviolet transmitting film) and each having a surface subjected to a release treatment were used (see Table 1).

(Measurement of Storage Elastic Modulus of Pressure Sensitive Adhesive After Curing and Definition of Cured Rate)

A laminate of plurality of pressure sensitive adhesive layer having a thickness of about 1.5 mm was used as a measurement sample. A dynamic viscoelasticity was measured under the following conditions using “Advanced Rheometric Expansion System (ARES)” manufactured by Rheometric Scientific, Inc.

### (Measurement Conditions)

Deformation mode: torsion

Measurement Frequency: 1 Hz

Temperature elevation rate: 5° C./minute

Measurement temperature: −50 to 150° C.

Shape: parallel plate (8.0 mmφ)

The exposed surface of a pressure sensitive adhesive layer of a pressure sensitive adhesive sheet including an ultraviolet transmitting separator was provided with the same separator, and using an UV lamp (energy density of UVA: 300 mW/cm²), an ultraviolet ray with an integrated light amount of 10000 mJ/cm² was applied from the separator-provided surface to cure the pressure sensitive adhesive. The dynamic viscoelasticity of the pressure sensitive adhesive was measured before and after curing, and from the measurement results, the storage elasticity of the sample at 80° C. was read. The storage elastic modulus of the pressure sensitive adhesive G₁ at 80° C. before curing was 7.0×10³ Pa, and the storage elastic modulus G₂ at 80° C. after curing was 2.4×10⁴ Pa. Where the storage elastic modulus of the sample at 80° C. is G, the cured rate of the sample is defined by the following expression.

Cured rate (%)=100×(G−G₁)/(G₂−G₁)

(Verification of Curing by Ultraviolet Ray from Fluorescent Lamp)

The exposed surface of a pressure sensitive adhesive layer of a pressure sensitive adhesive sheet (including an ultraviolet transmitting separator C) was provided with the same separator. The sample was left standing under fluorescent lamp illumination (distance between luminescent lamp and sample: 1.5 m), the pressure sensitive adhesive was sampled after 24 hours, after 48 hours and after 120 hours, and the cured rate was measured. A time-dependent change in cured rate of the pressure sensitive adhesive is shown in FIG. 5 where a usual fluorescent lamp (FLR32S N/N-X manufactured by Panasonic Corporation; color temperature: 5000 K) and an UV cut fluorescent lamp (FHF32EX N-NU manufactured by Panasonic Corporation; color temperature: 5000 K) are used as fluorescent lamps.

These results show that under UV cut fluorescent lamp illumination, the pressure sensitive adhesive was not cured, whereas under usual fluorescent lamp illumination, curing did not take place in a short time, but curing progressed with time after elapse of 24 hours.

[Preparation of Cell-Side Pressure Sensitive Adhesive Sheet]

### (Preparation of Base Polymer)

97 parts by weight of butyl acrylate (BA) and 3 parts by weight of acrylic acid (AA) as monomer components, 0.2 part by weight of azobisisobutyronitrile (AIBN) as a thermopolymerization initiator, and 233 parts by weight of ethyl acetate were put into a separable flask provided with a thermometer, a stirrer, a cooling tube and a nitrogen gas inlet. Nitrogen purge was performed for 1 hour while the mixture was stirred under nitrogen atmosphere at 23° C. Thereafter, the mixture was reacted at 60° C. for 5 hours to obtain an acryl-based base polymer with a weight average molecular weight (Mw) of 1100000.

(Preparation of Pressure Sensitive Adhesive Composition)

0.8 part by weight of trimethylolpropane tolylene diisocyanate (trade name “CORONATE L”, manufactured by Nippon Polyurethane Industry Co., Ltd.) as an isocyanate-based crosslinker and 0.1 part by weight of a silane coupling agent (trade name “KBM-403”, manufactured by Shin-Etsu Chemical Co., Ltd.) based on 100 parts by weight of the base polymer were added to the obtained acryl-based base polymer solution to prepare a pressure sensitive adhesive composition (solution).

(Formation of Pressure Sensitive Adhesive Sheet and Crosslinking)

The above prepared pressure sensitive adhesive composition was applied on a 38 μm-thick separator so as to have a thickness of 20μm after drying, and dried at 100° C. for 3 minutes to remove the solvent to obtain a pressure sensitive adhesive sheet. Thereafter, heating was carried out at 50° C. for 48 hours to perform a crosslinking treatment. As separators, two polyethylene terephthalate (PET) films having different ultraviolet transmittances (D: ultraviolet absorbing film; E: ultraviolet transmitting film) and each having a surface subjected to a release treatment were used (see Table 1).

[Polarizing Plate]

A polarizing plate was used as an optical film in which a transparent protecting film laminated on each of both surfaces of a polarizer formed of a 25 μm-thick stretched polyvinyl alcohol film impregnated with iodine. The transparent protecting film on one surface (image display cell side) of the polarizer was a 40 μm-thick acryl-based an, and the transparent protecting film on the other surface (viewing-side) was a 60 μm-thick triacetyl cellulose film.

[Preparation of Polarizing Plate with Pressure Sensitive Adhesive on Both Sides]

The cell-side pressure sensitive adhesive sheet was bonded to one surface of the polarizing plate, and the viewing-side pressure sensitive adhesive sheet was thereafter bonded to the other surface of the polarizing plate. In this way, a polarizing plate with a pressure sensitive adhesive on both sides was obtained in which a cell-side pressure sensitive adhesive sheet having a thickness of 20 μm bonded to one surface of a polarizing plate and a viewing-side pressure sensitive adhesive sheet having a thickness of 150 μm bonded to the other surface, and a separator releasably attached on each of the pressure sensitive adhesive layers.

[Evaluation]

Light is applied from both the surface sides of a polarizing plate with a pressure sensitive adhesive on both sides by a usual fluorescent lamp (distance between fluorescent lamp and sample: 1.5 m), and after 7 days, the viewing-side pressure sensitive adhesive was sampled, and the cured rate was measured. The results are shown in Table 1 along with the types and ultraviolet transmittances of separators used.

TABLE 1

| | | | | | Comparative | Comparative |
|---|---|---|---|---|---|---|
| | | | Example 1 | Example 2 | Example 1 | Example 2 |
| viewing- | type | | A | B | C | C |
| side | UV | 380 nm | 0.1% | 0.1% | 86% | 86% |
| separator | transmittance | 360 nm | 0.0% | 0.7% | 85% | 85% |
| cell-side | type | | D | E | E | D |
| separator | UV | 380 nm | 0.1% | 86% | 86% | 0.1% |
| | transmittance | 360 nm | 0.0% | 85% | 85% | 0.0% |

| | | | | |
|---|---|---|---|---|
| viewing-side pressure sensitive | 0% | 2% | 85% | 84% |
| adhesive cured rate | | | | |

[Evaluation Results]

As shown in Table 1, curing of the viewing-side pressure sensitive adhesive progressed after the polarizing plate was left standing under fluorescent lamp illumination for 7 days in Comparative Example 1 and Comparative Example 2, whereas curing of the viewing-side pressure sensitive adhesive hardly progressed in Examples 1 and 2 using an ultraviolet absorbing separator as the viewing-side separator. In Comparative Example 2, curing of the viewing-side pressure sensitive adhesive progressed although an ultraviolet absorbing separator was used as the cell-side separator. In Example 2, curing of the viewing-side pressure sensitive adhesive did not progress although an ultraviolet transmitting separator was used as the cell side separator. These results show that curing of the viewing-side pressure sensitive adhesive is caused mainly by irradiation with light from a surface on the viewing-side separator.

What is claimed is:

1. A pressure sensitive adhesive sheet comprising: a first pressure sensitive adhesive layer; and a first protective sheet releasably attached to one surface of the first pressure sensitive adhesive layer, wherein
the first pressure sensitive adhesive layer contains an ultraviolet curable pressure sensitive adhesive,
the first protective sheet has a transmittance of 1% or less to an ultraviolet ray with a wavelength of 360 nm.

2. The pressure sensitive adhesive sheet according to claim 1, wherein the first pressure sensitive adhesive layer has a thickness of 45 μm or more.

3. The pressure sensitive adhesive sheet according to claim 1, wherein the first pressure sensitive adhesive layer has a storage elastic modulus of 1×10² Pa to 5×10⁴ Pa at 80° C.

4. The pressure sensitive adhesive sheet according to claim 1, wherein a storage elastic modulus of the first pressure sensitive adhesive layer at 80° C. after irradiation with an ultraviolet ray with an integrated light amount of 10 J/cm² is 1.2 or more times as large as that before irradiation with the ultraviolet ray.

5. An optical film with a pressure sensitive adhesive comprising: an optical film including a polarizing plate; a first pressure sensitive adhesive layer provided on first main surface of the optical film; and a first protective sheet releasably attached on the first pressure sensitive adhesive layer, wherein
the first pressure sensitive adhesive layer contains an ultraviolet curable pressure sensitive adhesive,
the first protective sheet has a transmittance of 1% or less to an ultraviolet ray with a wavelength of 360 nm.

6. The optical film with a pressure sensitive adhesive according to claim 5, further comprising a second pressure sensitive adhesive layer on second main surface of the optical film, and a second protective sheet releasably attached on the second pressure sensitive adhesive layer.

7. The optical film with a pressure sensitive adhesive according to claim 6, wherein the second pressure sensitive adhesive layer has a thickness of 38 μm or less.

8. The optical film with a pressure sensitive adhesive according to claim 6, wherein the second pressure sensitive adhesive layer is non-ultraviolet curable pressure sensitive adhesive.

9. The optical film with a pressure sensitive adhesive according to claim 6, wherein the second protective sheet has a transmittance of 5% or more to an ultraviolet ray with a wavelength of 360

10. The optical (Urn with a pressure sensitive adhesive according to claim 5, wherein the first pressure sensitive adhesive layer has a thickness of 45 μm or more.

11. The optical (Urn with a pressure sensitive adhesive according to claim 5, wherein the first pressure sensitive adhesive layer has a storage elastic modulus of 1×10² Pa to 5×10⁴ Pa at 80° C.

12. The optical film with a pressure sensitive adhesive according to claim 5, wherein a storage elastic modulus of the first pressure sensitive adhesive layer at 80° C. after irradiation with an ultraviolet ray with an integrated light amount of 10 J/cm² is 1.2 or more times as large as that before irradiation with the ultraviolet ray.

13. A method for producing an image display device, the image display device comprising: a front transparent plate or a touch panel; an optical film including a polarizing plate; and an image display cell, arranged in this order from a viewing side, wherein
the method comprising the followings in the order:
providing an optical film with a pressure sensitive adhesive according to claim 6;
peeling off the second protective sheet from the second pressure sensitive adhesive layer, and then bonding the optical film and the image display cell to each other with the second pressure sensitive adhesive layer interposed therebetween;
peeling off the first protective sheet from the first pressure sensitive adhesive layer, and then bonding the optical film and the front transparent plate or the touch panel to each other with the first pressure sensitive adhesive layer interposed therebetween; and
applying an ultraviolet ray from a front side to cure the first pressure sensitive.
